(19) United States
(12) Patent Application Publication
(10) Pub. No.: US 2022/0215988 A1
(43) Pub. Date: Jul. 7, 2022

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: A-NAN YANG, Huaian (CN); HAN-RUN XIE, Huaian (CN); LU-YU CHANG, New Taipei (TW)

(21) Appl. No.: 17/561,923

(22) Filed: Dec. 25, 2021

(30) Foreign Application Priority Data
Jan. 4, 2021 (CN) 202120004342.6

(51) Int. Cl. H01B 11/20; H01B 11/00; H01B 7/17; H01B 11/10; H01B 11/18

(52) U.S. Cl. CPC H01B 11/203; H01B 11/002; H01B 11/1025; H01B 11/1091; H01B 11/1834; H01B 7/17

(57) ABSTRACT

A cable includes: a pair of core wires; a shielding layer covering the pair of core wires; and an outer insulating layer covering the shielding layer, wherein each of the core wires includes an inner conductor, an inner insulating layer covering the inner conductor, and a first shielding layer covering the inner insulating layer, and each core wire includes only one inner conductor.

### BACKGROUND OF THE INVENTION

### 1. Field of the Invention

The present invention relates generally to a cable, and more particularly to a cable used to transmit high frequency signals.

### 2. Description of Related Arts

U.S. Pat. No. 10,950,369, issued on Mar. 16, 2021, discloses a twin-axial cable including a pair of inner cables arranged side-by-side, or parallel to one another. Each of the inner cables includes a center conductor, a first dielectric layer surrounding the center conductor, and a middle conductor surrounding the first dielectric layer. The twin-axial cable also include one or more second dielectric layers surrounding each inner cable, an outer conductor surrounding the one or more second dielectric layers, and a protective outer jacket surrounding the outer conductor.

With the development and popularization of electronic technology products, signal cables are widely used in household appliances, instrumentation, automation equipment, data centers, servers, switches, cloud computing and 5G as a tool for signal transmission. However, in the signal transmission process, the cable is susceptible to interference from external electromagnetic signals, so it is often necessary to use a shielding structure to eliminate or reduce the interference of the external electromagnetic field, and to prevent the leakage of the transmission signal. Therefore, it is necessary to provide an improved cable with strong anti-interference performance, stable signal transmission, reliability.

### SUMMARY OF THE INVENTION

A main object of the present invention is to provide a cable which has good shielding effect and stable signal transmission capability.

To achieve the above-mentioned object, a cable comprises: a pair of core wires; a shielding layer covering the pair of core wires; and an outer insulating layer covering the shielding layer; wherein each of the core wires includes an inner conductor, an inner insulating layer covering the inner conductor, and a first shielding layer covering the inner insulating layer, and each core wire includes only one inner conductor.

Compared to prior art, the present invention has the advantage that the double shielding of the first shielding layer covering the core wire and the shielding layer covering the pair of core wires improves the shielding effect of the cable and ensures the reliability of signal transmission. Also, the cable of the present invention has the ability to transmit high-speed data signals with a frequency greater than 40 GHz.

### BRIEF DESCRIPTION OF THE DRAWING

FIG. 1 is a front view of a first embodiment of a cable of the present invention;

FIG. 2 is a front view of a second embodiment of the cable of the present invention;

FIG. 3 is the curve of differential insertion loss tested with the structure in FIG. 1 and American Wire Gauge (AWG) 30 cable;

FIG. 4 is the curve of single-ended insertion loss tested with the structure in FIG. 1 and AWG 30 cable; and

FIG. 5 is the curve of single-ended insertion loss attenuation difference in FIG. 4.

### DETAILED DESCRIPTION OF THE PREFERRED EMBODIMENT

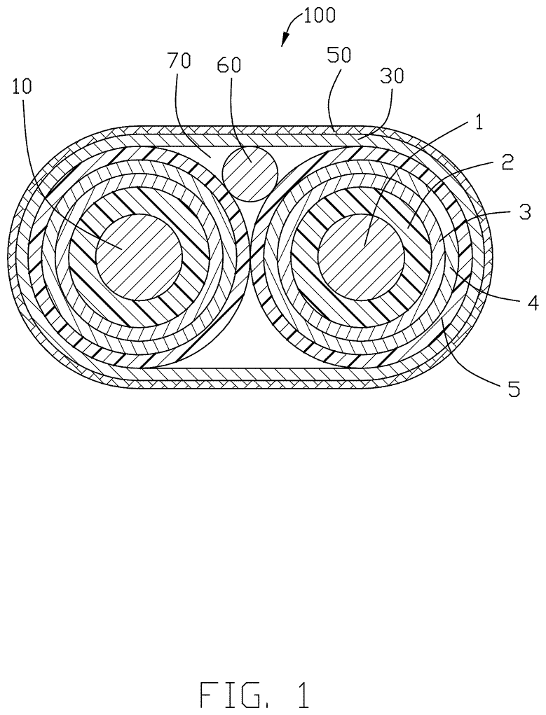

FIG. 1 shows the first embodiment of a cable 100 of the present invention. The cable 100 includes a pair of core wires 10, a shielding layer 30 covers the pair of core wires 10, an outer insulating layer 50 covers the shielding layer 30 and a ground wire 60 is located between the shielding layer 30 and the pair of core wires 10.

In this embodiment, Each core wire 10 includes an inner conductor 1 and an inner insulating layer 2 covering the inner conductor 1, a first shielding layer 3 covering the inner insulating layer 2, a second shielding layer 4 covering the first shielding layer 3 and an heat-adhesive PET (polyethylene terephthalate) layer 5 covering the second shielding layer 4. The inner conductor 1 is used for transmitting high-speed signal. The inner insulating layer 2 of each core wire 10 is extruded and molded to cover the inner conductor 1. The inner insulating layer 2 can be one of PP (polypropylene), PE (polyethylene), FEP (Fluorinated ethylene propylene), and PFA (Polyfluoroalkoxy). The first shielding layer 3 is a pure metal tape. The second shielding layer 4 is a metal wire. Preferably, in this embodiment, the first shielding layer 3 is a metal copper tape or a metal aluminum tape. The second shielding layer 4 is pure copper wire. The first shielding layer 3 covers the inner insulating layer 2 in a longitudinal wrapping way. The pure copper wire wraps the first shielding layer 3 in a spiral winding way. The heat-adhesive PET layer 5 fixes the second shielding layer 4. The heat-adhesive PET layer 5 wraps the second shielding layer 4 in a spiral winding way. The shielding layer 30 can be any one of aluminum foil, copper foil, metal copper tape or metal aluminum tape. The upper and lower sides between the shielding layer 30 and the pair of core wires 10 forms air gaps 70. The ground wire 60 is provided in the upper side air gap 70 between the shielding layer 30 and the core wire 10. The outer insulating layer 50 can be provided as one layer or multiple layers, and its material can be PET tape. In the embodiment, each core wire 10 adopts the double-layer shielding of the first shielding layer 3 of pure metal and the second shielding layer 4 wound by metal wires, so the shielding effect is better, and the pure metal shielding layer can meet the attenuation requirements of higher frequencies.

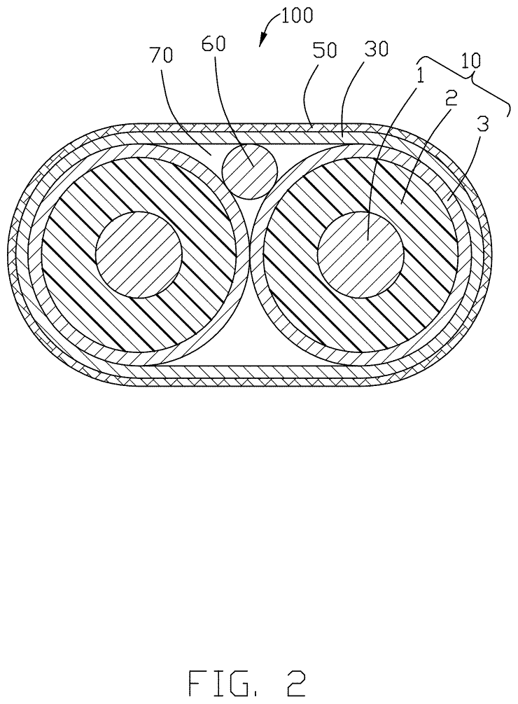

FIG. 2 shows the second embodiment of the cable 100. Compared with the first embodiment, in this embodiment, the second shielding layer 4 and the heat-adhesive PET layer 5 in the first embodiment are reduced. The cable 100 reduces the second shielding layer 4 and the heat-adhesive PET layer 5, which makes the cable lighter, simpler in structure, more convenient to manufacture, and cheaper in price.

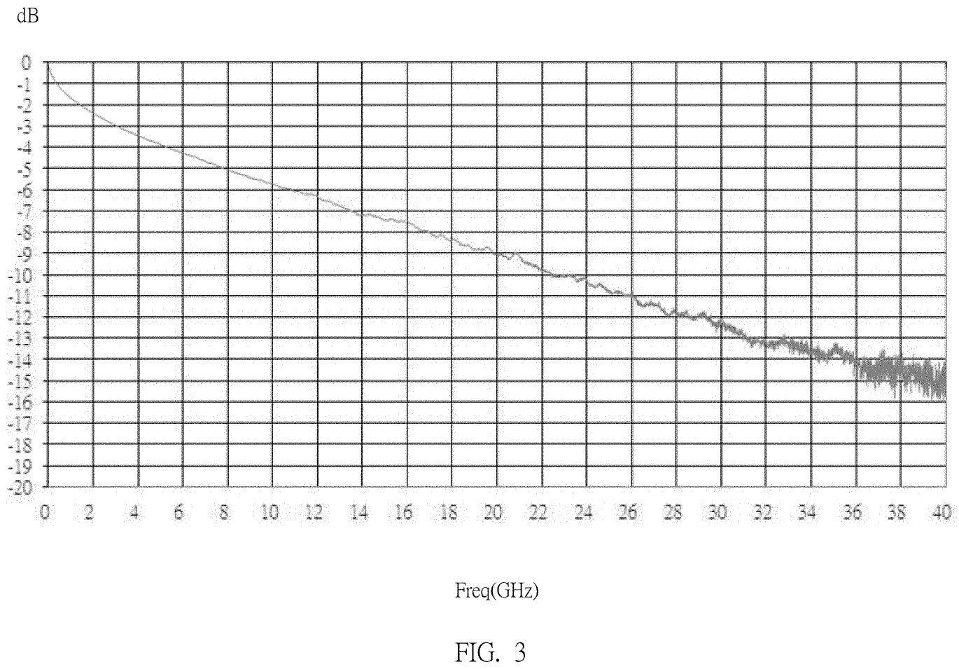

Refer to FIGS. 3-5, which is the performance test curve of the cable, using the cable structure in the first embodiment and 30 AWG as the test sample. The abscissa is the frequency, in GHz, and the ordinate is the loss, in dB.

FIG. 3 is the SDD21 (Differential Insertion Loss) curve of the cable. It can be seen that as the frequency increases, the differential insertion loss has no cliff-like attenuation before 40 GHz, and the attenuation is less than −16 dB at 40 GHz.

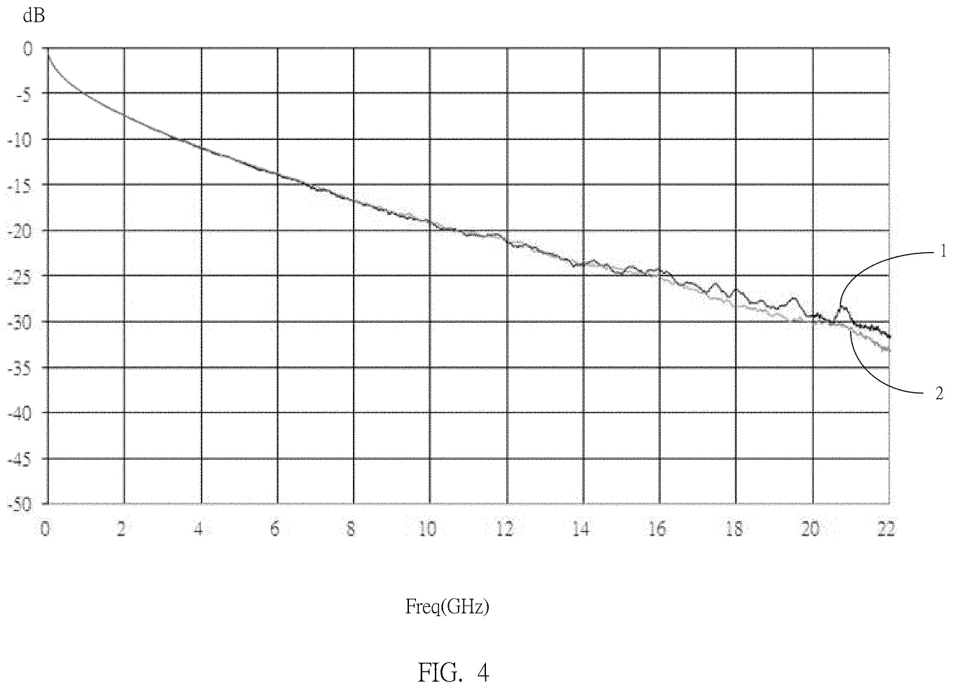

FIG. 4 is the curve of SEIL (single-ended insertion loss). The curve measured by one conductor of the cable is curve 1, and the curve measured by the other conductor is curve 2. It can be seen that the single-ended insertion loss of the two conductors of the cable has no cliff-type attenuation at 22 GHz, and the attenuation is less than −35 dB at 22 GHz, and the single-ended attenuation consistency of the two wires is better.

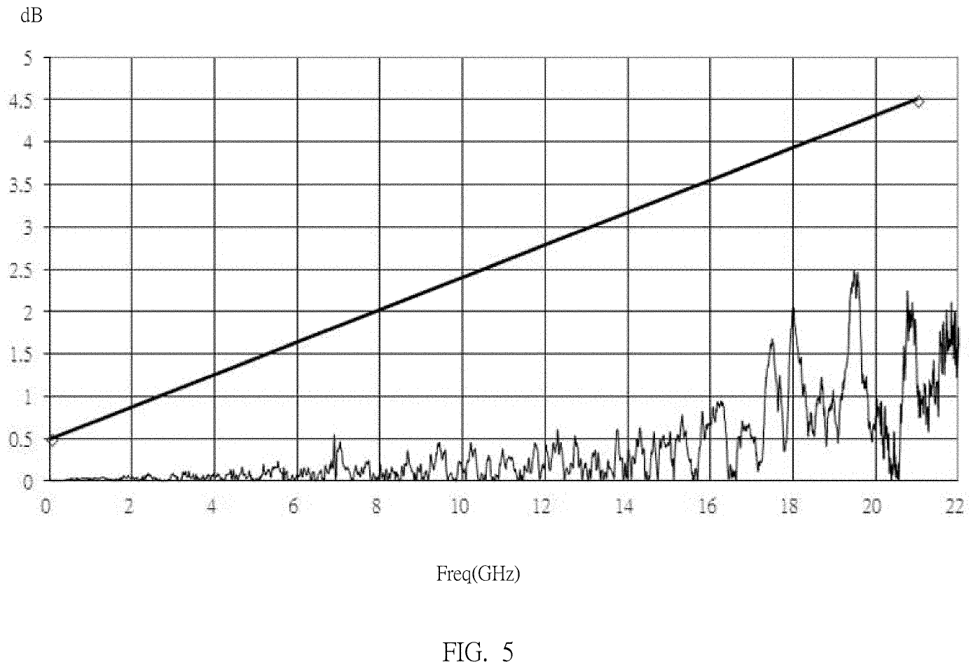

FIG. 5 is the curve of SEILD (single-ended insertion loss attenuation difference). It is the absolute value of curve 1 minus the value of curve 2 in FIG. 4, and it can be seen that the absolute value is below 2.5 dB at 22 GHz.

The cable of the present invention is provided with a first shielding layer on each core wire, and then a shielding layer covering the pair of core wires is arranged outside the pair of core wires. With the double shielding layer, the shielding effect is better and the anti-interference ability is stronger. The cable of the present invention has a high-speed data transmission capability with a signal transmission frequency greater than 40 GHz.

The above are only some of the embodiments of the present invention, but not all of the embodiments. Any equivalent changes to the technical solutions of the present invention by those skilled in the art by reading the description of the present invention are covered by the claims of the present invention.

What is claimed is:

1. A cable comprising:
a pair of core wires;
a shielding layer covering the pair of core wires; and
an outer insulating layer covering the shielding layer; wherein
each of the core wires includes an inner conductor, an inner insulating layer covering the inner conductor, and a first shielding layer covering the inner insulating layer, and each core wire includes only one inner conductor.

2. The cable as claimed in claim 1, wherein the first shielding layer is a pure metal tape.

3. The cable as claimed in claim 2, wherein the first shielding layer is a metal copper tape or a metal aluminum tape.

4. The cable as claimed in claim 3, further comprising a second shielding layer covering the first shielding layer, the second shielding layer being a copper wire.

5. The cable as claimed in claim 4, wherein the first shielding layer wraps the inner insulating layer in a longitudinal wrapping way, and the second shielding layer wraps the first shielding layer in a spiral winding way.

6. The cable as claimed in claim 5, further comprising a heat-adhesive PET layer covering the second shielding layer, the heat-adhesive PET layer covering the second shielding layer in a spiral winding manner.

7. The cable as claimed in claim 1, further comprising at least one ground wire arranged between the shielding layer and the core wire.

8. The cable as claimed in claim 1, wherein the shielding layer is selected from the group consisting of aluminum foil, copper foil, metal copper tape, and metal aluminum tape.

9. The cable as claimed in claim 1, wherein the inner insulating layer is selected from the group consisting of PP, PE, FEP, and PFA.
